(19) United States
(12) Patent Application Publication
(10) Pub. No.: US 2024/0044463 A1
(43) Pub. Date: Feb. 8, 2024

(54) PENDANT LIGHT ASSEMBLIES

(71) Applicant: Hangar Design Studios LLC, Highland Park, NJ (US)

(72) Inventors: Daniel Termini, Philadelphia, PA (US); Timothy Mellema, Highland Park, NJ (US)

(21) Appl. No.: 17/881,188

(22) Filed: Aug. 4, 2022

(51) Int. Cl. F21S 8/06; F21V 21/26

(52) U.S. Cl. CPC F21S 8/061; F21V 21/26

(57) ABSTRACT

A pendant light assembly includes a pendant assembly and a head. The pendant assembly includes a housing, a shell assembly extending from the housing, and a swivel arm that is pivotably coupled to the housing by a ball joint. The swivel arm supports a socket on a distal end portion thereof. The head is secured to the socket by a socket flange. The head is movable relative to the shell assembly as the socket moves relative to the housing in response to pivoting movement of the swivel arm relative to the shell assembly.

### TECHNICAL FIELD

This disclosure relates to light assemblies and, more particularly, to pendant light assemblies.

### BACKGROUND

Pendant light assemblies are light fixtures which are suspended from an overlying support, such as ceiling or beam, for example. Pendant light assemblies are noteworthy for their ability to create interesting and pleasing visual effects, whether suspended singly or in a group, and are therefore popular for use in foyers, dining rooms, restaurants, and similar locations.

It will be appreciated that aesthetic appeal is a critical component in installations of the kind described above. Although many prior pendant light assemblies have been attractive in a general sense, certain challenges remain. For example, many prior pendant light assemblies require unsightly brackets or similar fittings to support them on the ends of the suspension cords, or worse yet, use chains and hooks or other cumbersome and/or visually unappealing arrangements.

Although aesthetic factors play a role in decorative pendant light assemblies, utilitarian considerations cannot be completely ignored. For example, the suspension structure of the pendant light assemblies must be sturdy, durable, and able to withstand loads imposed by both the weight of the light assembly itself and external forces acting thereon such as those created by cleaning and other disturbances. The structure must also allow the bulb to be changed or subject to other maintenance without excessive difficulty. Moreover, it is desirable that decorative light assemblies are manufactured at a reasonable cost while presenting an interesting and appealing appearance.

### SUMMARY

According to an aspect of this disclosure, a pendant light assembly includes a mounting assembly, an elongated member assembly depending from the mounting assembly, a pendant assembly secured to the elongated member assembly, and a head assembly selectively attached to the pendant assembly. The pendant assembly includes a shell assembly and a swivel mount assembly. The swivel mount assembly includes a swivel assembly and a socket. The swivel assembly includes a housing and a swivel arm that are movably coupled together by a ball joint.

In aspects, the swivel arm may include a proximal ball and the housing may define a ball cavity. The proximal ball may be received within the ball cavity to define the ball joint and longitudinally fix the swivel arm relative to the housing.

In aspects, the pendant light assembly may include a socket that is threadedly coupled to a distal portion of the swivel arm. The socket may be threadedly coupled to the head assembly. The head assembly may include a head and a head mounting assembly. The head mounting assembly may be mounted to the head and threadedly coupled to the socket. The head mounting assembly may include an internal clasp and an external clasp. The internal clasp may be supported within the head. The external clasp may be disposed on an outer surface of the head and secured to the internal clasp.

In aspects, the pendant light assembly may include a socket flange disposed between and supported by the internal clasp and the external clasp. The socket flange may be threadedly coupled to an outer surface of the socket. The internal clasp and the external clasp may be secured together by fasteners. The socket flange may be secured to the external clasp by fasteners. The socket flange may extend through the internal clasp and seat on the internal clasp by a lip of the socket flange.

In aspects, the elongated member assembly may include a threaded nipple that threadedly couples to a proximal end portion of the housing of the swivel assembly.

In aspects, the swivel arm may be polyaxially pivotable relative to the housing to move the head assembly between a plurality of positions relative to the pendant assembly and a longitudinal axis defined by the housing.

According to another aspect, this disclosure is directed to a pendant light assembly including a pendant assembly and a head assembly. The pendant assembly includes a shell assembly and a swivel mount assembly. The shell assembly includes a first shell and a second shell that is disposed on the first shell. The swivel mount assembly includes a housing and a swivel arm that is polyaxially coupled to the housing. The head assembly is secured to the swivel arm and polyaxially movable relative to the shell assembly as the swivel arm moves relative to the housing to position the head assembly in a plurality of different positions relative to the shell assembly.

In aspects, the head assembly may include a head and a head mounting assembly that couples the head to the pendant assembly. The head mounting assembly may include two clasps and a socket flange supported between the two clasps. The two clasps may be disposed in parallel relation to one another and extend transversely across a longitudinal axis of the swivel arm. The socket flange may be coupled to the swivel mount assembly. Stoppers may be coupled to at least one of the clasps. Each of the clasps may support at least one cushion that is positioned to engage the head.

In aspects, the housing may define a longitudinal axis. The head assembly may be axially movable relative to the swivel arm as the head assembly rotates about the longitudinal axis. The swivel arm may support a socket that is received within the head mounting assembly to couple the head assembly to the pendant assembly.

In aspects, the socket may be threadedly coupled to the head mounting assembly.

According to yet another aspect, this disclosure is directed to a pendant light assembly including a housing, a shell assembly extending from the housing, and a swivel arm that is pivotably coupled to the housing by a ball joint. The swivel arm supports a socket on a distal end portion thereof. The pendant light assembly includes a head secured to the socket by a socket flange. The head is movable relative to the shell assembly as the socket moves relative to the housing in response to pivoting movement of the swivel arm relative to the shell assembly.

Other aspects, features, and advantages will be apparent from the description, the drawings, and the claims that follow.

### BRIEF DESCRIPTION OF THE DRAWINGS

The accompanying drawings, which are incorporated in and constitute a part of this specification, illustrate aspects of this disclosure and, together with a general description of this disclosure given above, and the detailed description given below, explain the principles of this disclosure, wherein:

FIG. 1 is a perspective view of a pendant light assembly in accordance with the principles of this disclosure;

FIG. 2 is another perspective view of the pendant light assembly of FIG. 1;

FIG. 3 is an enlarged, perspective view of a distal portion of the pendant light assembly of FIG. 1 with portions thereof shown in phantom for clarity;

FIG. 4 is a perspective view, with parts separated, of the pendant light assembly of FIG. 1;

FIG. 5 is an enlarged, perspective view of the distal portion of the pendant light assembly of FIG. 1 with parts of the distal portion shown separated for clarity;

FIG. 6 is an enlarged perspective view of a swivel assembly of the pendant light assembly of FIG. 1, the swivel assembly having a ball joint thereof shown in a first position;

FIG. 7 is an enlarged, cross-sectional view of a pendant assembly of the pendent light assembly of FIG. 1 as taken along section line 7-7 shown in FIG. 5, the pendant assembly having a head assembly mount shown in a first position;

FIG. 8 is a perspective view of the swivel assembly of FIG. 6 with the ball joint thereof shown in a second position;

FIG. 9 is a cross-sectional view of the pendant assembly of FIG. 7 with the head assembly mount shown in a second position;

FIG. 10 is an enlarged, cross-sectional view of a head assembly of the distal portion of the pendant light assembly of FIG. 1 as taken along section line 10-10 shown in FIG. 5;

FIGS. 11 and 12 are progressive, cross-sectional views of the distal portion of the of the pendant light assembly of FIG. 1 as taken along respective section lines 11-11 and 12-12;

FIGS. 13-23 are side views of various pendant light assemblies in accordance with the principles of this disclosure;

FIG. 24 is a perspective view, with parts separated, of another pendant light assembly in accordance with the principles of this disclosure; and

FIG. 25 is an enlarged, cross-sectional view of a pendant assembly of the pendant light assembly of FIG. 24.

### DETAILED DESCRIPTION

Aspects of this disclosure are described in detail with reference to the drawings, in which like reference numerals designate identical or corresponding elements in each of the several views. As used herein, the term “distal” refers to that portion of structure closer to a user, while the term “proximal” refers to that portion of structure, farther from the user.

In the following description, well-known functions or constructions are not described in detail to avoid obscuring the present disclosure in unnecessary detail.

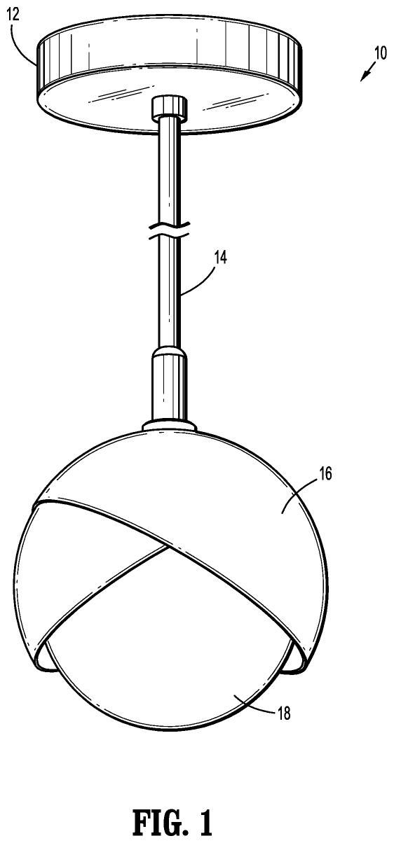

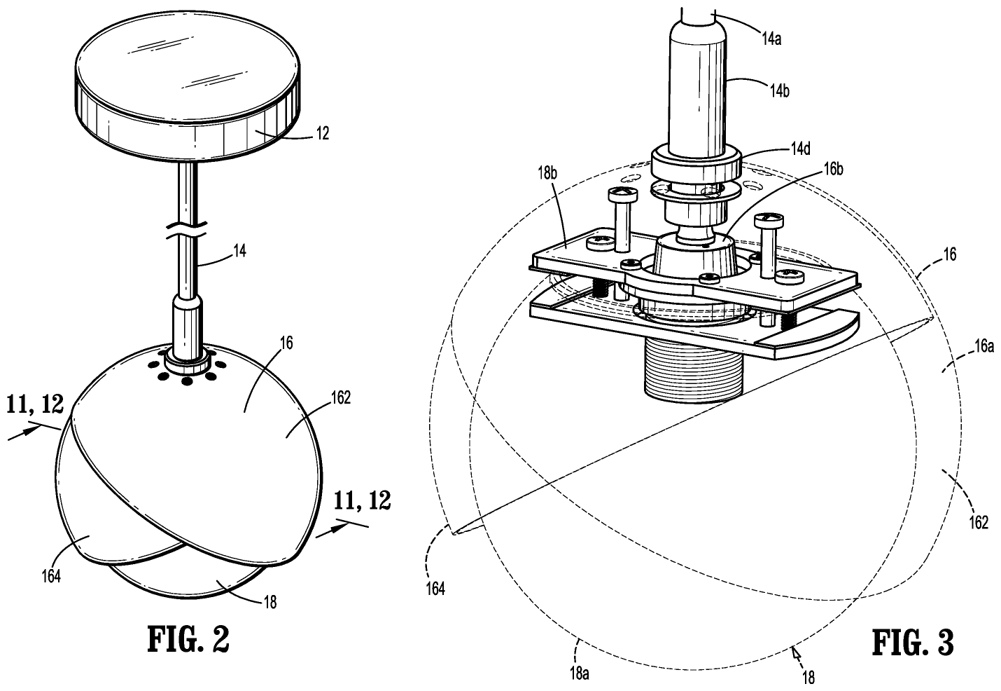

With reference to FIGS. 1 and 2, a pendant light assembly 10 includes a proximal mounting assembly 12, an elongated member assembly 14 depending from proximal mounting assembly 12, a pendant assembly 16 secured to a distal end portion of elongated member assembly 14, and a head assembly 18 selectively attached to pendant assembly 16.

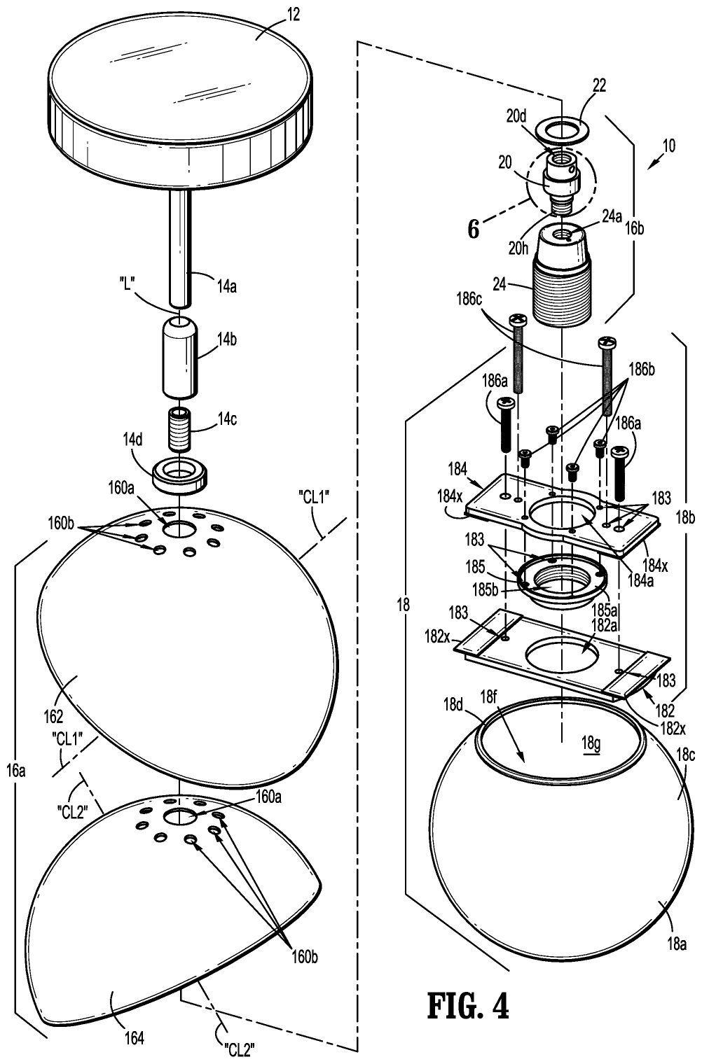

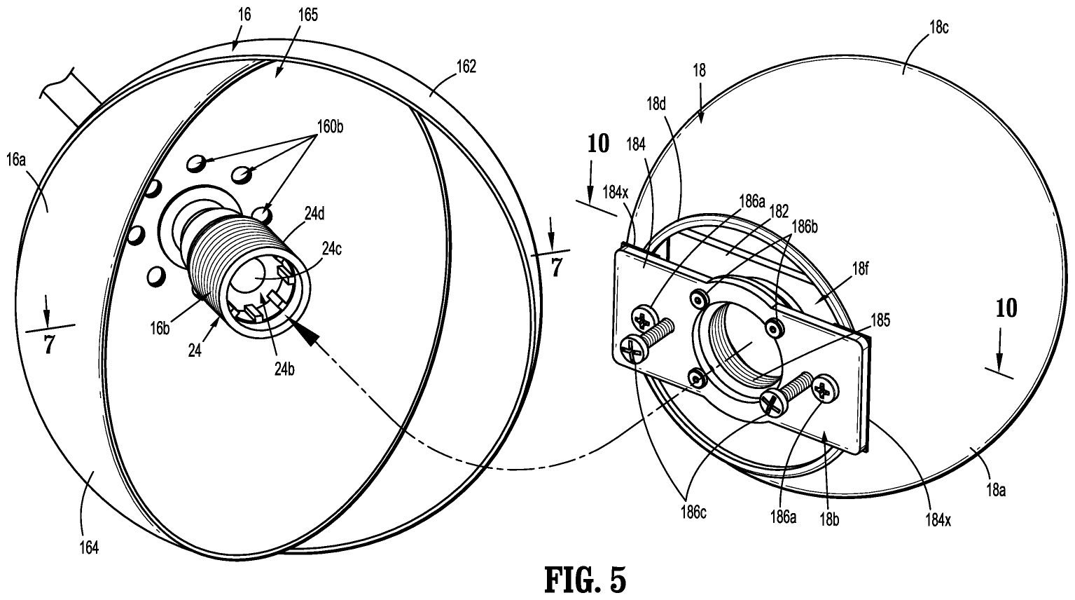

As seen in FIGS. 3 and 4, elongated member assembly 14 of pendant light assembly 10 defines a longitudinal axis “L” and includes a proximal tube 14a (e.g., a rigid tube made from, for example, any suitable metallic material) depending from proximal mounting assembly 12, a distal sleeve 14b supported on a distal end portion of proximal tube 14a, a threaded nipple 14c threadedly coupled to a distal portion of distal sleeve 14b, and an annular flange 14d that encircles a distal portion of distal sleeve 14b. Distal sleeve 14b may be in the form of a finial. Any of these components, such as distal sleeve 14b and/or annular flange 14d, may be manufactured via milling and/or Computer Numerical Control (CNC) machining, for example, and/or utilizing any other suitable manufacturing technique.

Pendant assembly 16 of pendant light assembly 10 includes a shell assembly 16a and a swivel mount assembly 16b.

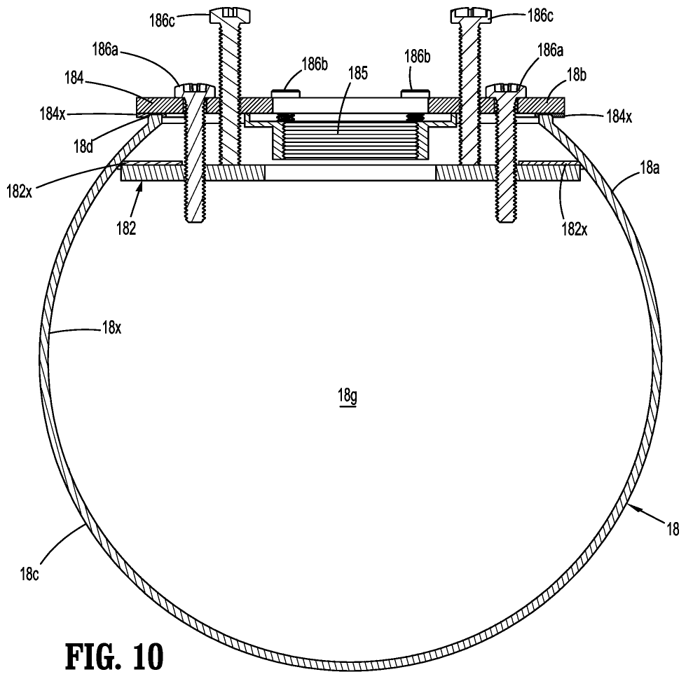

Shell assembly 16a of pendant assembly 16 includes an upper shell 162 and a lower shell 164 that is mounted underneath upper shell 162 such that upper and lower shells 162, 164 are disposed in a layered arrangement with upper and lower shells 162, 164 being disposed laterally offset relative to one another and positioned to define a triangular and/or crescent-shaped opening 165. Upper and lower shells 162, 164 may have a bowl-shaped or hemispherical configuration as seen in FIG. 4, although any suitable shape and/or configuration may be provided. Upper shell 162 defines a centerline “CL1” therethrough and lower shell 164 defines a centerline “CL2” therethrough. In the layered arrangement, centerline “CL1” of upper shell 162 is transverse to centerline “CL2”, and centerlines “CL1” and “CL2” may be perpendicular in some aspects. Each of upper and lower shells 162, 164 defines an alignment opening 160a therethrough which receives a distal portion of threaded nipple 14c of elongated member assembly 14 and a proximal portion of swivel mount assembly 16b of pendant assembly 16 therethrough as seen in FIG. 7. Each of upper and lower shells 162, 164 further defines an array of spaced apart apertures 160b about a circumference of each alignment opening 160a and which enable light to project proximally through upper and lower shells 162, 164.

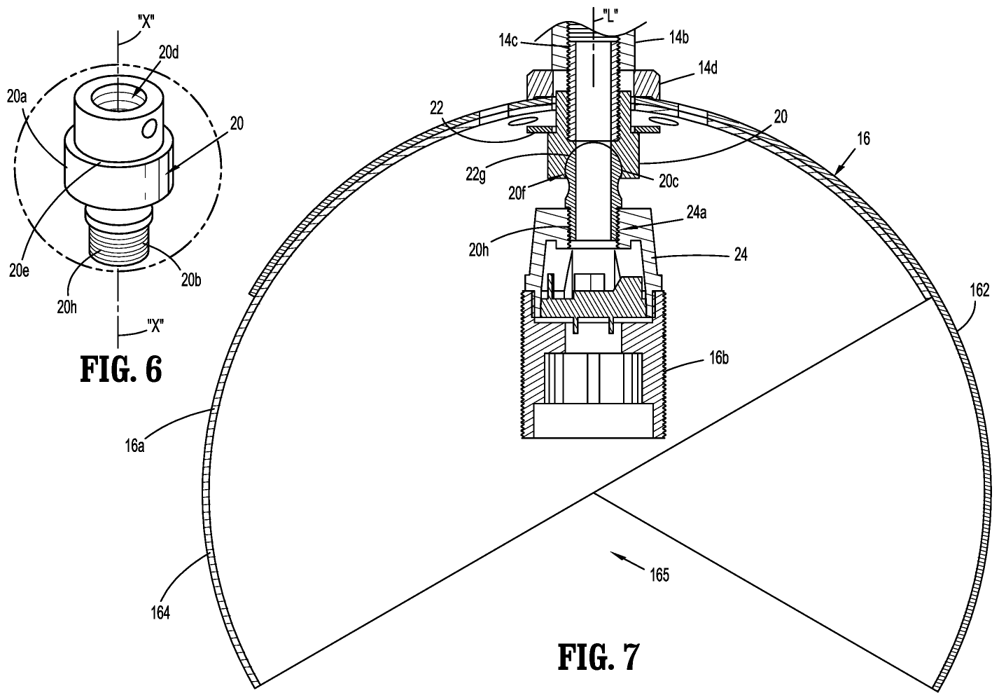

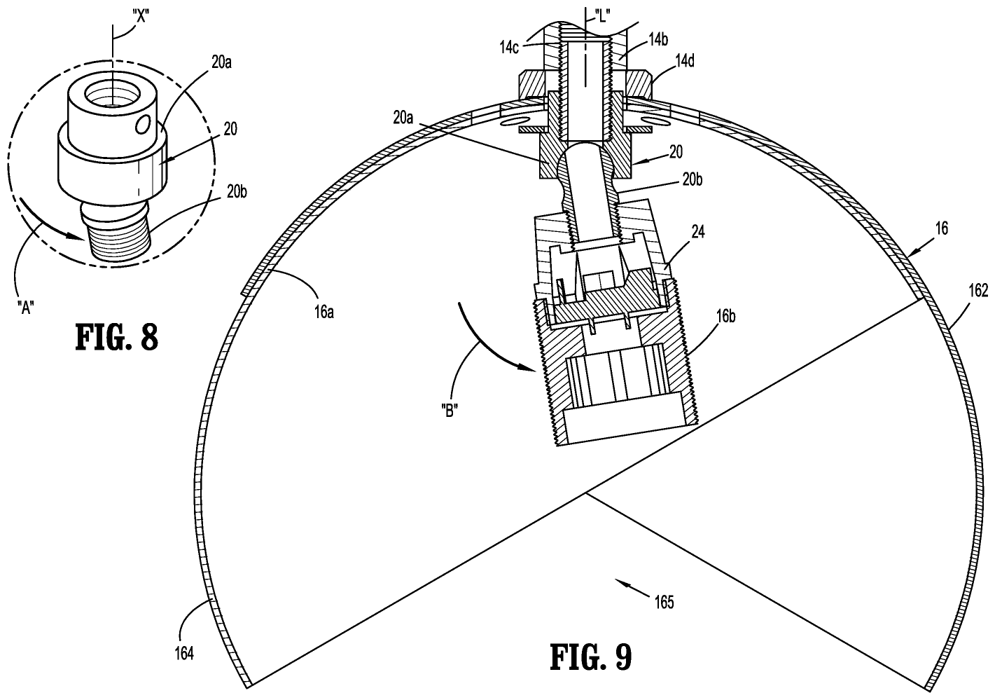

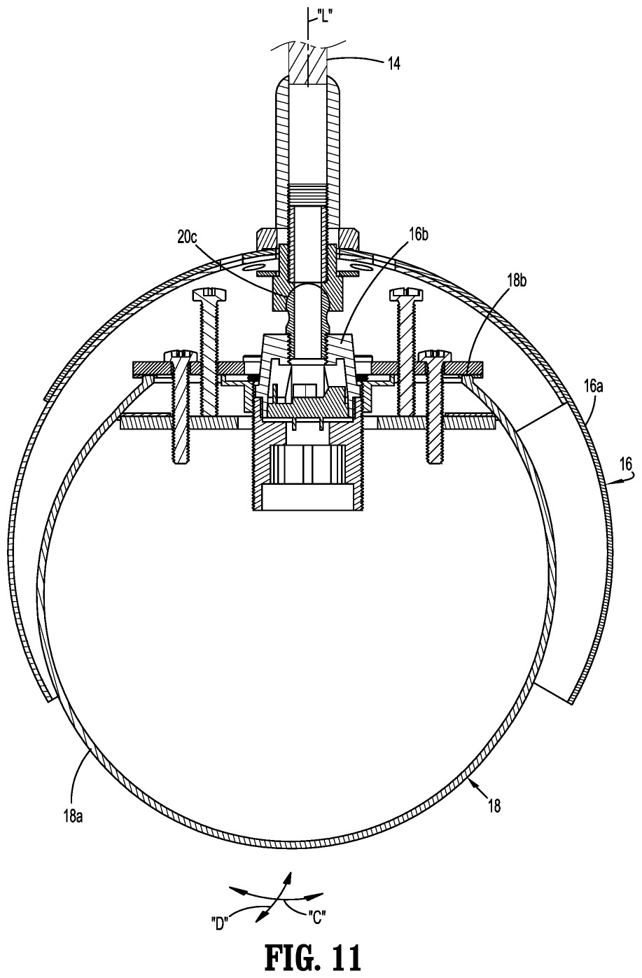

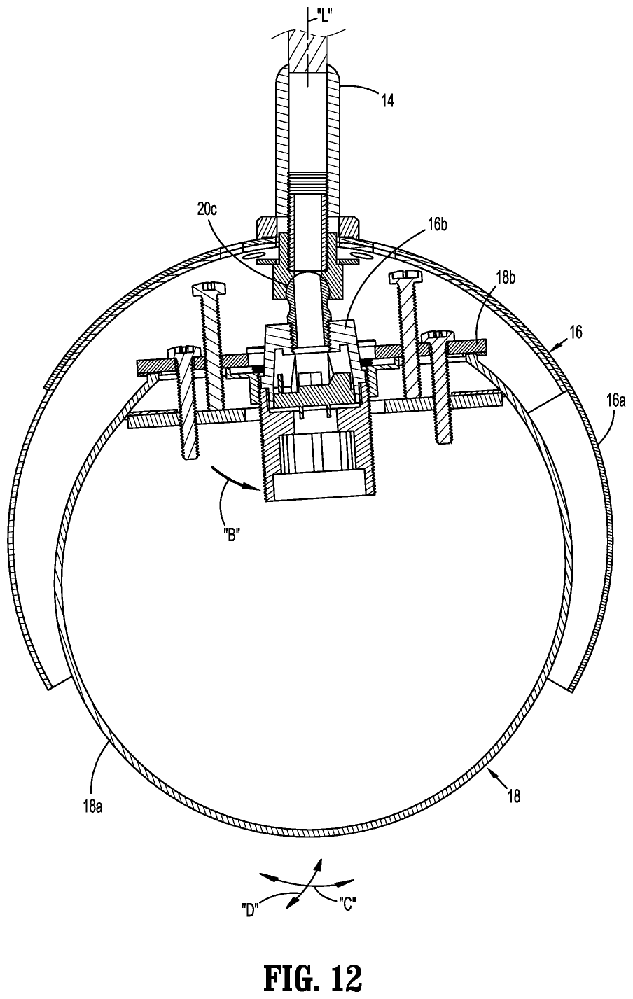

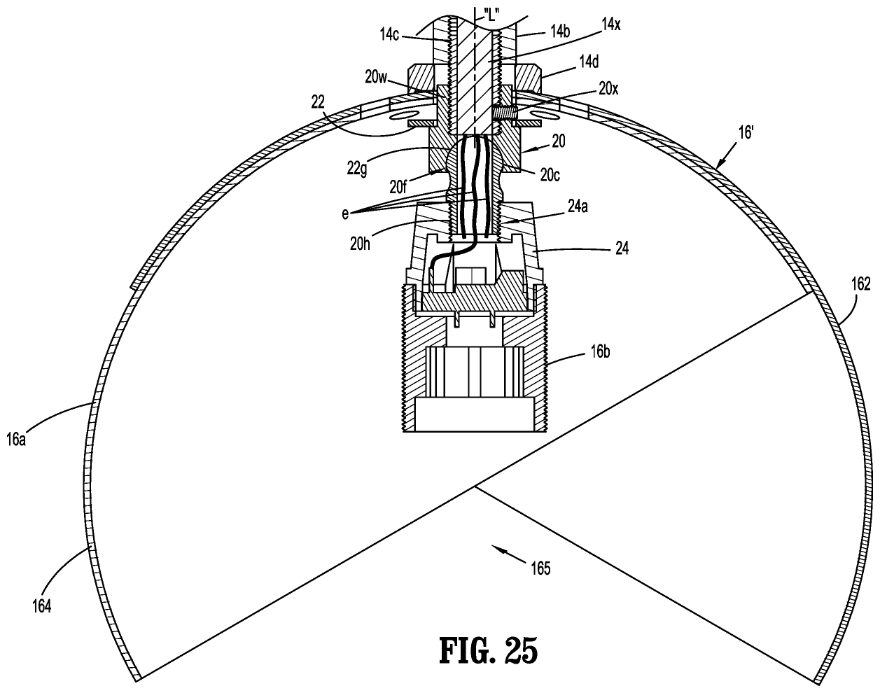

With reference to FIGS. 4-9, swivel mount assembly 16b of pendent assembly 16 threadedly couples to threaded nipple 14c of elongated member assembly 14 and includes a swivel assembly 20, a washer 22, and a socket 24. Swivel assembly 20 includes a housing 20a and a swivel arm 20b that are movable coupled together by a ball joint 20c that is configured to enable swivel arm 20b to move polyaxially relative to housing 20a and having sufficient frictional engagement to enable swivel arm 20b to maintain an articulated position relative to housing 20a when pendant light assembly 10 is fully assembled. Housing 20a defines a threaded bore 20d through a proximal end portion thereof that threadedly receives threaded nipple 14c therein. Housing 20a further includes a ledge 20e that seats washer 22. A distal end portion of housing 20a defines a ball cavity 20f therein. Swivel arm 20b has proximal ball 20g that is received within ball cavity 20f such that swivel arm 20b and housing 20a are longitudinally fixed with housing 20a and swivel arm 20b polyaxially movable relative to one another about a central longitudinal axis “X” defined through swivel assembly 20, as indicated by arrow “A” shown in FIG. 8. Swivel arm 20b further includes a threaded outer surface 20h on a distal end portion thereof that threadedly couples to a proximal end portion of socket 24 to enable swivel arm 20b to articulate socket 24 relative to housing 20a, as indicated by arrow “B” shown in FIG. 9 as swivel arm 20b articulates relative to housing 20a. Socket 24 includes a threaded bore 24a on a proximal end portion thereof that threadedly couples to threaded outer surface 20h of swivel arm 20b. Socket 24 further includes a distal bulb bore 24b in distal end portion thereof that is configured to receive a light bulb (not shown) therein. Socket 24 further includes one or more electrical contacts 24c therein that are electrically coupled to electrical components (e.g., electrical wires “e” extending through, for example, components of pendant light assembly 10 such as elongated member assembly 14—see FIG. 25) for electrically coupling the light bulb to an electrical energy source (e.g., hard wired). An outer distal surface 24d of socket 24 is threaded for threadedly coupling to head assembly 18 of pendant light assembly 10.

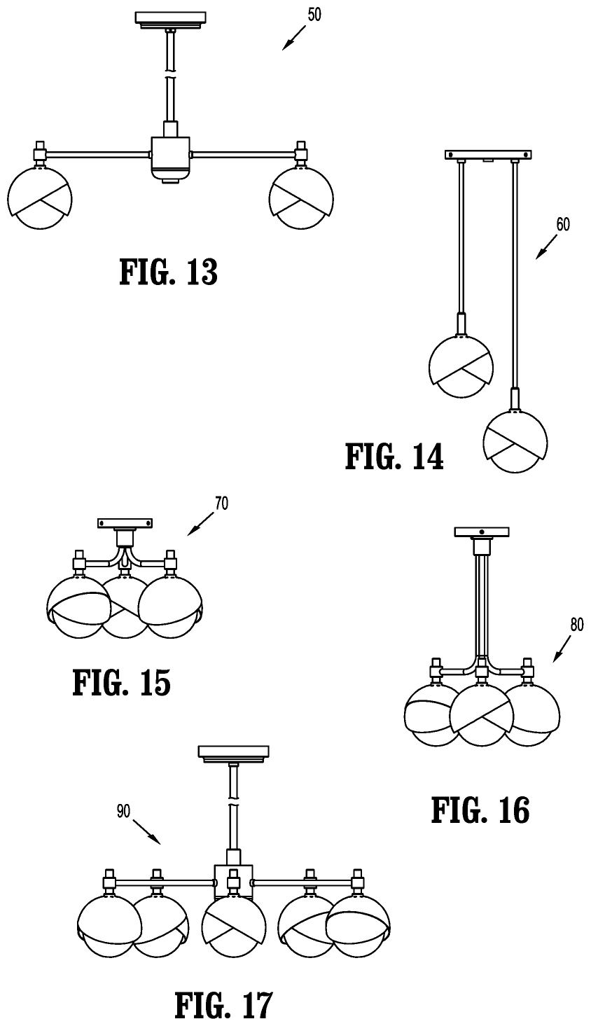

Turning now to FIGS. 3-5 and 10, head assembly 18 of pendant light assembly 10 includes a head 18a and a head mounting assembly 18b. Head 18a includes a bulbous portion 18c and a proximal edge 18d that defines an opening 18f into a cavity 18g defined in bulbous portion 18c for surrounding a light bulb (not shown). Head mounting assembly 18b includes an internal clasp 182, an external clasp 184, a socket flange 185, clasp fasteners 186a, flange fasteners 186b, and stoppers 186c. Clasp fasteners 186a, flange fasteners 186b, and stoppers 186c may be in the form of fasteners such as threaded screws. Internal and external clasps 182, 184 have a rectangular configuration and define central openings 182a, 184a therethrough, respectively. Central opening 182a of internal clasp 182 is configured to receive socket flange 185 therein and central opening 184a of external clasp 184 is configured to receive socket 24 therethrough. Internal and external claps 182, 184 and socket flange 185 define a plurality of threaded fastener openings 183 for threadedly receiving the various fasteners 186a, 186b, and/or stoppers 186c to secure the socket flange 185 and the internal and external clasps 182, 184 together. Internal and external claps 182, 184 further include cushions 182x and 184x thereon. Cushions 184x of external clasp 184 are positioned to sit on proximal edge 18d of head 18a, externally of head 18a to protect external surfaces of head 18a from external clasp 184. Similarly, with internal clasp 182 recessed within cavity 18g of head 18a, cushions 182x of internal clasp 182 are positioned to abut an inner surface 18x of head 18a to protect inner surface 18x of head 18a from edges of internal clasp 182. Socket flange 185 includes a lip 185a that is supported on a top surface of internal clasp 182 and defines a threaded opening 185b therethrough that is configured to receive socket 24 therein.

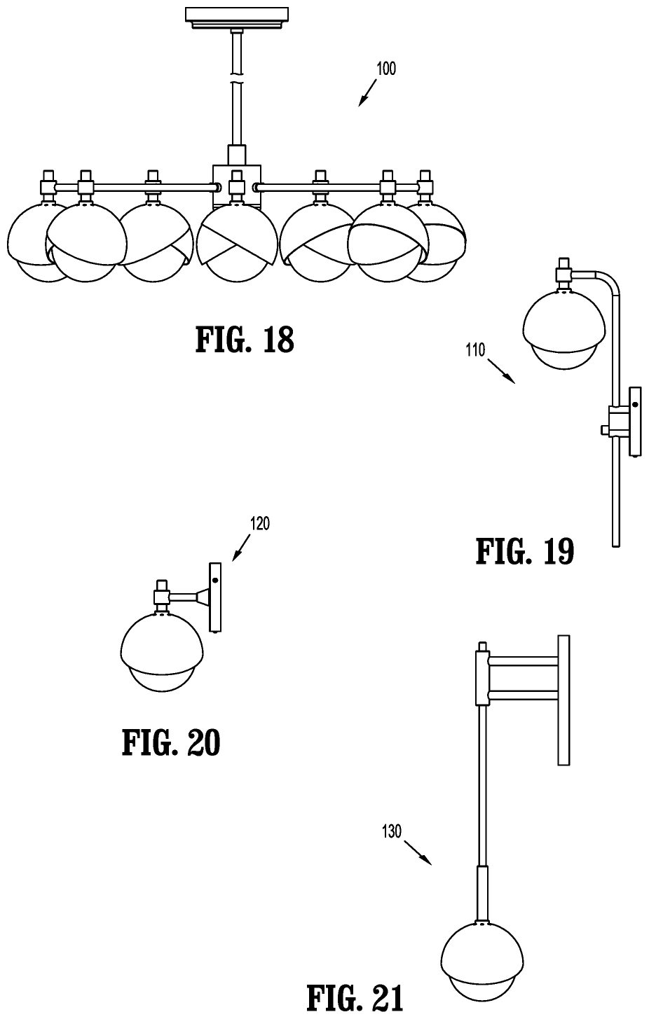

With reference to FIGS. 11 and 12, when head assembly 18 is coupled to pendant assembly 16 via threadedly securing outer distal surface 24d of socket 24 within socket flange 185 of head mounting assembly 18b, head assembly 18 can be polyaxially movable relative to pendant assembly 16 via swivel mount assembly 16b, as indicated by arrows “C” and “D” shown in FIGS. 11 and 12, respectively. And, as detailed above, ball joint 20c of swivel assembly 20, namely, ball cavity 20f of housing 20a and proximal ball 20g of swivel arm 20b are configured to enable head assembly 18 to be maintained (e.g., movably fixed) in unarticulated and/or articulated positions relative to pendant assembly 16 and longitudinal axis “L” for selectively changing a direction of light emanating from a light bulb of the pendant light assembly 10 when the pendant light assembly 10 is turned on (e.g., via a wall-mounted switch or other smart home device, etc. in electrical communication therewith).

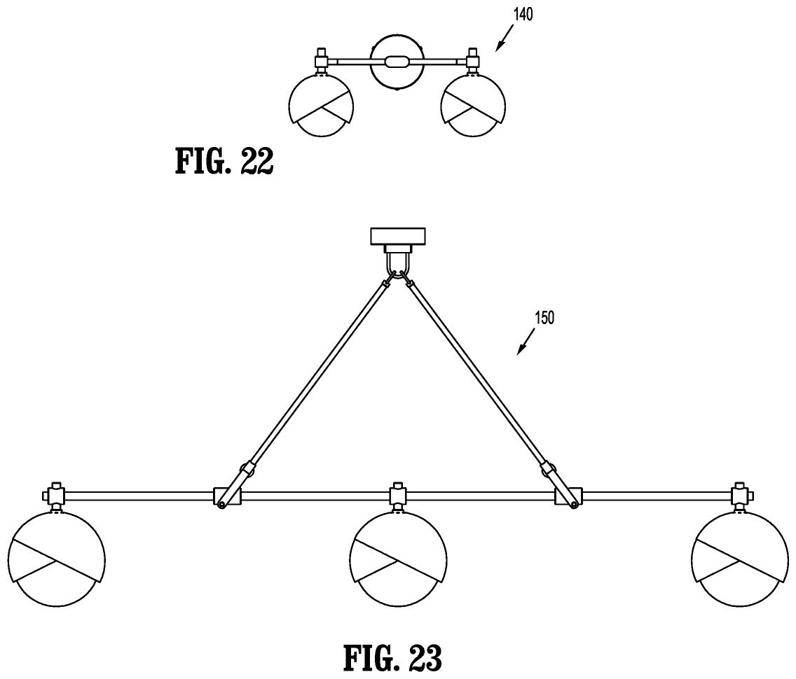

As seen in FIGS. 13-23, pendant light assemblies of this disclosure can be provided in any suitable configuration. For example, such pendant light assemblies can have any number and/or arrangement of mounting assemblies, elongated member assemblies, pendant assemblies and/or head assemblies as illustrated by pendant light assemblies 50-150.

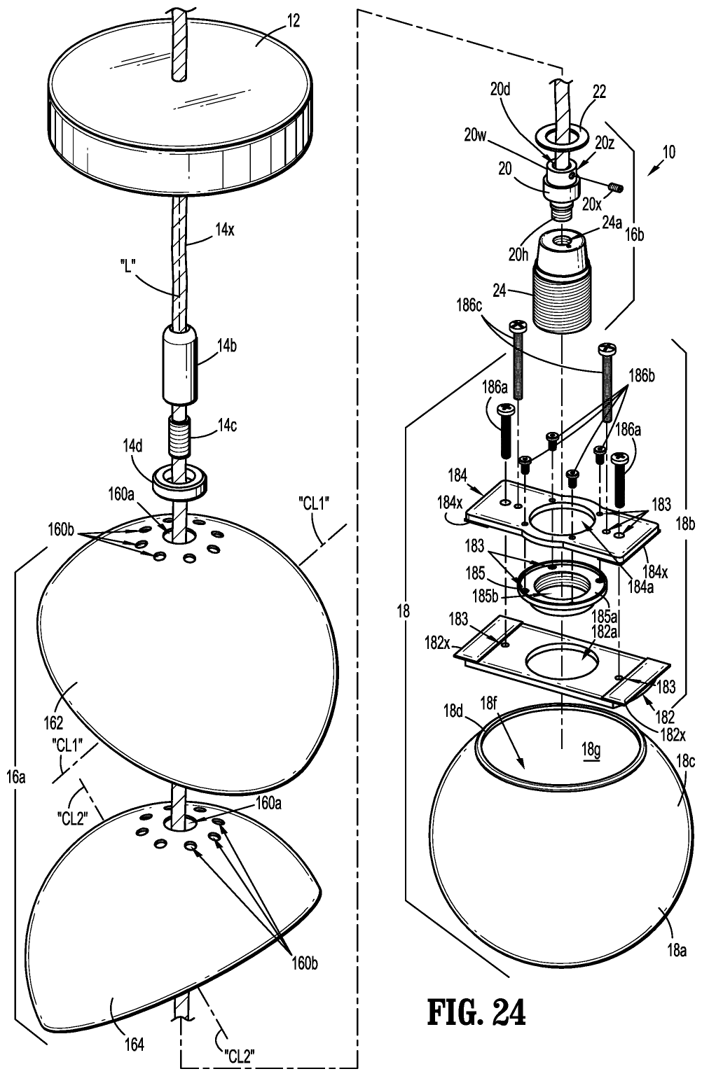

With reference to FIGS. 24 and 25, one pendant light assembly, referred to generally as 16′, is substantially similar to pendant assembly 16, but includes an elongated member in the form of a cord member 14x that extends through various components of pendant assembly 16′ as seen in FIG. 24. In particular, a distal end of cord member 14x is received within bore 20d of swivel assembly 20 and secured within bore 20d via a set screw 20x (e.g., a cup point set screw) advanced into a set screw bore 20z defined in a proximal sidewall 20w of swivel assembly 20. Cord member 14x may be made of any suitable cloth and/or fabric.

The phrases “in an aspect,” “in aspects,” “in various aspects,” “in some aspects,” “in other aspects” or the like may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

Securement of any of the components of the disclosed devices may be effectuated using known securement techniques such welding, crimping, gluing, fastening, etc.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that this disclosure is not limited to the precise aspects described, and that various other changes and modifications may be effectuated by one skilled in the art without departing from the scope or spirit of the disclosure. Additionally, the elements and features shown or described in connection with certain aspects may be combined with the elements and features of certain other aspects without departing from the scope of this disclosure, and that such modifications and variations are also included within the scope of this disclosure. Accordingly, the subject matter of this disclosure is not limited by what has been particularly shown and described.

What is claimed is:

1. A pendant light assembly, comprising:
a mounting assembly;
an elongated member assembly depending from the mounting assembly;
a pendant assembly secured to the elongated member assembly, the pendant assembly including a shell assembly and a swivel mount assembly, the swivel mount assembly including a swivel assembly and a socket, the swivel assembly including a housing and a swivel arm that are movably coupled together by a ball joint; and
a head assembly selectively attached to the pendant assembly.

2. The pendant light assembly of claim 1, wherein the swivel arm includes a proximal ball and the housing defines a ball cavity, the proximal ball received within the ball cavity to define the ball joint and longitudinally fix the swivel arm relative to the housing.

3. The pendant light assembly of claim 2, further comprising a socket that is threadedly coupled to a distal portion of the swivel arm, the socket threadedly coupled to the head assembly.

4. The pendant light assembly of claim 3, wherein the head assembly includes a head and a head mounting assembly, the head mounting assembly is mounted to the head and threadedly coupled to the socket.

5. The pendant light assembly of claim 4, wherein head mounting assembly includes an internal clasp and an external clasp, the internal clasp supported within the head, the external clasp disposed on an outer surface of the head and secured to the internal clasp.

6. The pendant light assembly of claim 5, further comprising a socket flange disposed between and supported by the internal clasp and the external clasp, the socket flange threadedly coupled to an outer surface of the socket.

7. The pendant light assembly of claim 6, wherein the internal clasp and the external clasp are secured together by fasteners.

8. The pendant light assembly of claim 7, wherein the socket flange is secured to the external clasp by fasteners, and wherein the socket flange extends through the internal clasp and seats on the internal clasp by a lip of the socket flange.

9. The pendant light assembly of claim 1, wherein the elongated member assembly includes a threaded nipple that threadedly couples to a proximal end portion of the housing of the swivel assembly.

10. The pendant light assembly 1, wherein the swivel arm is polyaxially pivotable relative to the housing to move the head assembly between a plurality of positions relative to the pendant assembly and a longitudinal axis defined by the housing.

11. A pendant light assembly, comprising:
a pendant assembly including a shell assembly and a swivel mount assembly, the shell assembly including a first shell and a second shell that is disposed on the first shell, the swivel mount assembly including a housing and a swivel arm that is polyaxially coupled to the housing; and
a head assembly secured to the swivel arm and polyaxially movable relative to the shell assembly as the swivel arm moves relative to the housing to position the head assembly in a plurality of different positions relative to the shell assembly.

12. The pendant light assembly of claim 11, wherein the head assembly includes a head and a head mounting assembly that couples the head to the pendant assembly.

13. The pendant light assembly of claim 12, wherein the head mounting assembly includes two clasps and a socket flange supported between the two clasps, the socket flange coupled to the swivel mount assembly.

14. The pendant light assembly of claim 13, wherein stoppers are coupled to at least one of the clasps.

15. The pendant light assembly of claim 13, wherein each of the clasps supports at least one cushion that is positioned to engage the head.

16. The pendant light assembly of claim 11, wherein the housing defines a longitudinal axis, and wherein the head assembly is axially movable relative to the swivel arm as the head assembly rotates about the longitudinal axis.

17. The pendant light assembly of claim 12, wherein the swivel arm supports a socket that is received within the head mounting assembly to couple the head assembly to the pendant assembly.

18. The pendant light assembly 17, wherein the socket is threadedly coupled to the head mounting assembly.

19. The pendant light assembly of claim 13, wherein the two clasps are disposed in parallel relation to one another and extend transversely across a longitudinal axis of the swivel arm.

20. A pendant light assembly, comprising:
a housing;
a shell assembly extending from the housing;
a swivel arm that is pivotably coupled to the housing by a ball joint, the swivel arm supporting a socket on a distal end portion thereof; and
a head secured to the socket by a socket flange, the head movable relative to the shell assembly as the socket moves relative to the housing in response to pivoting movement of the swivel arm relative to the shell assembly.
